(19) United States
(12) Patent Application Publication
(10) Pub. No.: US 2012/0287455 A1
(43) Pub. Date: Nov. 15, 2012

(54) CHECKING SYSTEM, CONTROL METHOD OF CHECKING SYSTEM, AND STORAGE MEDIUM

(75) Inventor: Yasuaki Sawano, Kawasaki-shi (JP)

(73) Assignee: CANON KABUSHIKI KAISHA, Tokyo (JP)

(21) Appl. No.: 13/466,526

(22) Filed: May 8, 2012

(30) Foreign Application Priority Data
May 12, 2011 (JP) 2011-107000

(51) Int. Cl. G06F 3/12

(52) U.S. Cl. 358/1.13

(57) ABSTRACT

A predetermined sheet indicating a portion of a printed matter determined to be abnormal as a checking result is added while retaining the productivity of a checking system as much as possible. A control method for controlling the checking system includes reading a sheet on which an image is printed based on image data by a printing unit and checking the read sheet, and performing control to add a predetermined sheet indicating a portion of a printed matter that is determined to be abnormal, to the sheet printed by the printing unit in a case where the number of pages of the image data is plural, and not to add the predetermined sheet to the sheet printed by the printing unit in a case where the number of pages of the image data is one.

### BACKGROUND OF THE INVENTION

1. Field of the Invention

The present invention relates to a checking system, a control method of a checking system, and a storage medium.

2. Description of the Related Art

A conventional checking system is equipped with a checking apparatus that checks a print result of an image obtained by a print device (discussed in Japanese Patent Application Laid-Open No. 2004-195680). The checking apparatus includes an image reading device that obtains, as checking image data, an image printed on a sheet conveyed along a conveyance path. It is determined whether a print result is OK or NG based on the checking image data obtained by the image reading apparatus. As a consequence, it can be automatically determined whether the print result is OK or NG. A user reprints an image of a printed matter whose print result is determined as NG and combines the reprinted image with a printed matter whose print result is determined as OK.

However, if the image of the printed matter whose image is determined as NG is subsequently reprinted in the conventional checking system, the user does not easily understand in which point of the printed matter whose image is determined as OK, the reprinted matter should be placed. For example, as discussed in Japanese Patent Application Laid-Open No. 2004-195680, if it is determined that the print result is NG as the checking result, only it is notified that the print result is NG to the user, and it is not easily understood in which point of the printed matter determined as OK, the reprinted matter is placed.

### SUMMARY OF THE INVENTION

According to an aspect of the present invention, a checking system includes a checking unit configured to read a sheet on which an image is printed based on image data by a printing unit and check the read sheet, and a control unit configured to perform control to add a predetermined sheet indicating a portion of a printed matter that is determined to be abnormal by the checking unit to the sheet printed by the printing unit in a case where the number of pages of the image data is greater than one, and not to add the predetermined sheet to the sheet printed by the printing unit in a case where the number of pages of the image data is one.

Further features and aspects of the present invention will become apparent from the following detailed description of exemplary embodiments with reference to the attached drawings.

### BRIEF DESCRIPTION OF THE DRAWINGS

The accompanying drawings, which are incorporated in and constitute a part of the specification, illustrate exemplary embodiments, features, and aspects of the invention and, together with the description, serve to explain the principles of the invention.

FIG. 1 illustrates a configuration of a checking system according to an exemplary embodiment of the present invention.

FIG. 2 illustrates a flowchart of a checking method of the checking system according to the exemplary embodiment.

FIG. 3 illustrates an example of a user interface (UI) displayed on an operation unit.

FIG. 4 illustrates another example of the UI displayed on the operation unit.

FIG. 5 illustrates another flowchart of the checking method of the checking system.

FIG. 6 illustrates a configuration of a print system according to the exemplary embodiment.

### DESCRIPTION OF THE EMBODIMENTS

Various exemplary embodiments, features, and aspects of the invention will be described in detail below with reference to the drawings.

### <Description of System Configuration>

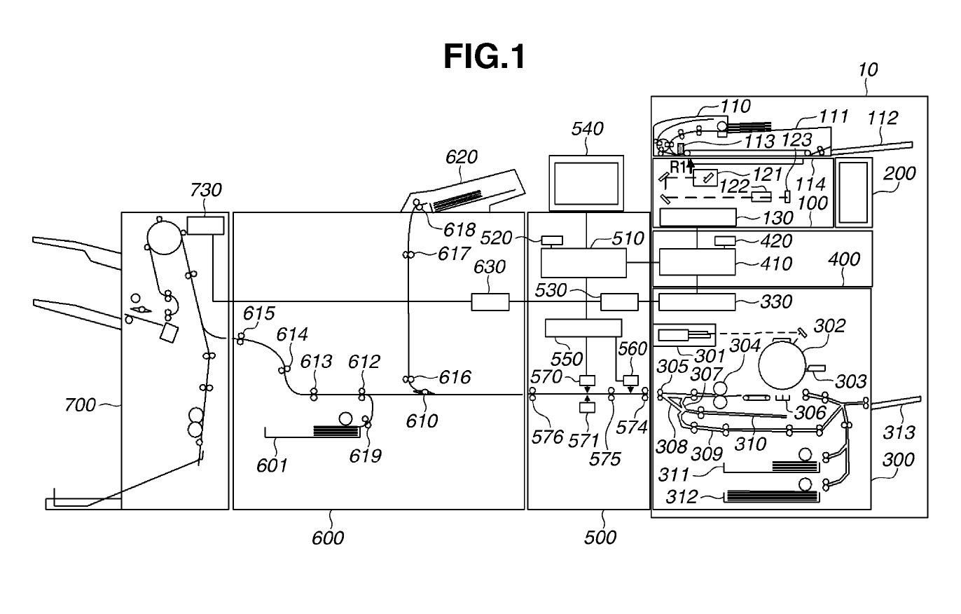

FIG. 1 illustrates a configuration of a checking system according to an exemplary embodiment of the present invention. The checking system includes an image forming apparatus 10, a checking apparatus 500, an inserter 600, and a finisher 700. The image forming apparatus 10 includes a scanner unit 100 that reads an image of a document and generates image data corresponding to the read image, and a printer unit 300 that prints the image read by the scanner unit 100 on a sheet. According to the present exemplary embodiment, as an example of the image forming apparatus 10, a multi functional peripheral (MFP) is described with a plurality of functions having a copy function and a page description language (PDL) print function. Alternatively, the image forming apparatus 10 may be a single function peripheral (SFP) having one function.

The checking apparatus 500 checks a printed matter that is printed and conveyed by the image forming apparatus 10. The inserter 600 can insert a specific sheet (insertion sheet such as a tab sheet or a color sheet) between sheets that are sequentially conveyed along a conveyance path. The finisher 700 discharges the printed matter conveyed from the inserter 600 to a sheet discharge tray, and executes stapling or saddle stitching bookbinding of the printed matter if necessary. The image forming apparatus 10, the checking apparatus 500, the inserter 600, and the finisher 700 are detachable from each other, and an arrangement order can be changed according to user's desire. According to the present exemplary embodiment, the checking apparatus 500, the inserter 600, and the finisher 700 are sequentially connected to each other in this order from the checking apparatus which is the nearest to the image forming apparatus 10, in the print system.

It is defined that the image forming apparatus 10 side is upstream and the finisher 700 side is downstream. In other words, the checking apparatus 500 is provided on the downstream side of the image forming apparatus 10, and the inserter 600 is provided on the downstream side of the checking apparatus 500.

The image forming apparatus 10, the checking apparatus 500, the inserter 600, and the finisher 700 are connected via control lines as illustrated in FIG. 1. The control lines of the image forming apparatus 10, the checking apparatus 500, the inserter 600, and the finisher 700 are connected to each other when connecting the apparatuses to each other. The individual apparatus includes a control unit having a central processing unit (CPU), a read only memory (ROM), and a random access memory (RAM). The control unit of the apparatus can transmit and receive a command or data via the control line.

The checking apparatus 500 includes a device control unit 530. The device control unit 530 obtains image data of a document read by the image forming apparatus 10, compares the obtained image data with image data on sheets read by optical units 570 and 571 to check a state of a printed matter. The device control unit 530 further notifies the inserter 600 of a checking result.

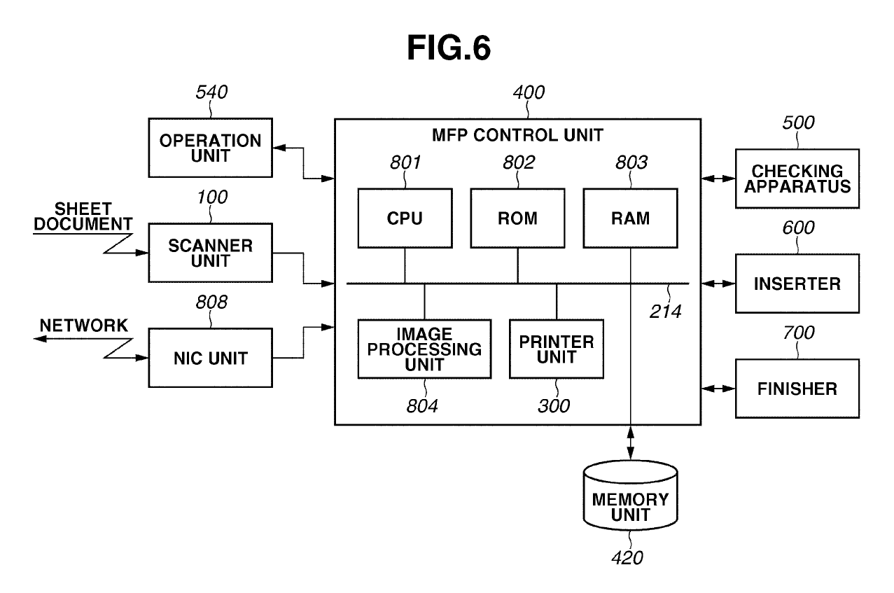

FIG. 6 illustrates a block diagram of a configuration of the print system. A central processing unit (CPU) 801 reads onto a random access memory (RAM) 803 and executes a program stored in a read only memory (ROM) 802, thereby systematically controlling the print system. The ROM 802 stores various programs to be read by the CPU 801. The RAM 803 functions as a work area of the CPU 801. An image processing unit 804 performs color space conversion or resolution conversion of image data in response to an instruction from the CPU 801. The printer unit 300 forms an image on a sheet fed from a sheet feeding device 809. The sheet on which the image is formed is conveyed to the device connected on the downstream side of the image forming apparatus 10. A memory unit 420 is, e.g., a hard disk drive (HDD) to store the image data and the program.

An multi function peripheral (MFP) control unit 400 transmits and receives signals to/from an operation unit 540, the scanner unit 100, an network interface card (NIC) unit 808, the sheet feeding device 809, the checking apparatus 500, the inserter 600, and the finisher 700, and communicates data with the devices to control the devices. The MFP control unit 400 also stores the image data received from the scanner unit 100 in the memory unit 420, and prints the stored image data with the printer unit 300. The MFP control unit 400 further analyzes the print data received via the NIC unit 808, and executes printing of the analyzed print data with the printer unit 300. Since the inserter 600 is connected on the downstream side of the checking apparatus 500 in the print system according to the present exemplary embodiment, it is possible to insert an insertion sheet whose print result is determined by the checking apparatus 500 as NG (abnormal) without suspending the printing.

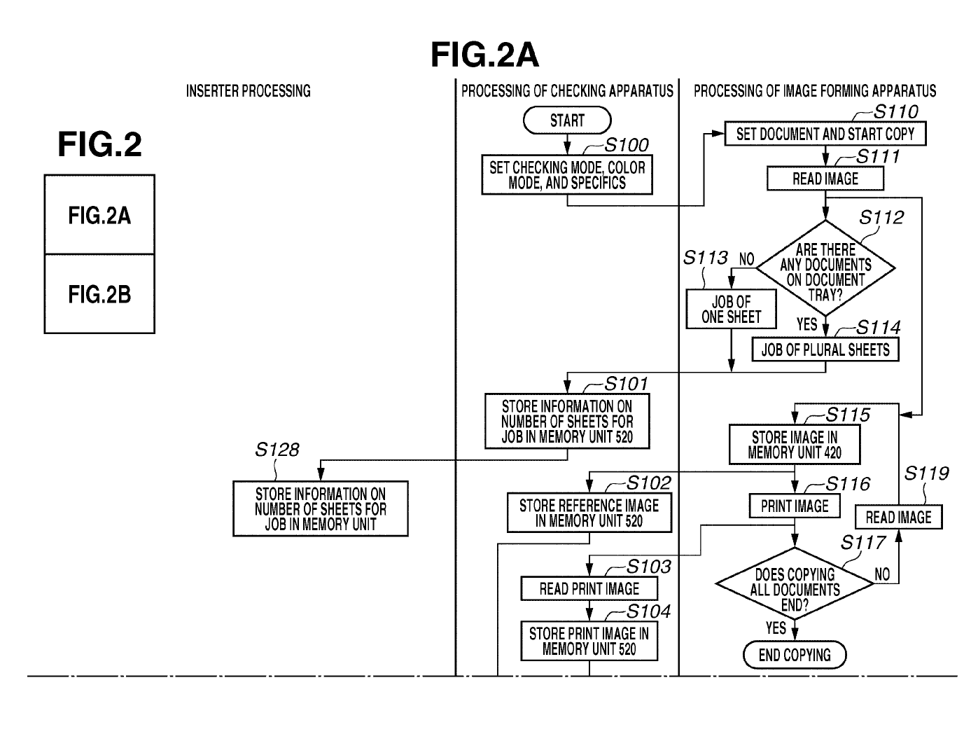

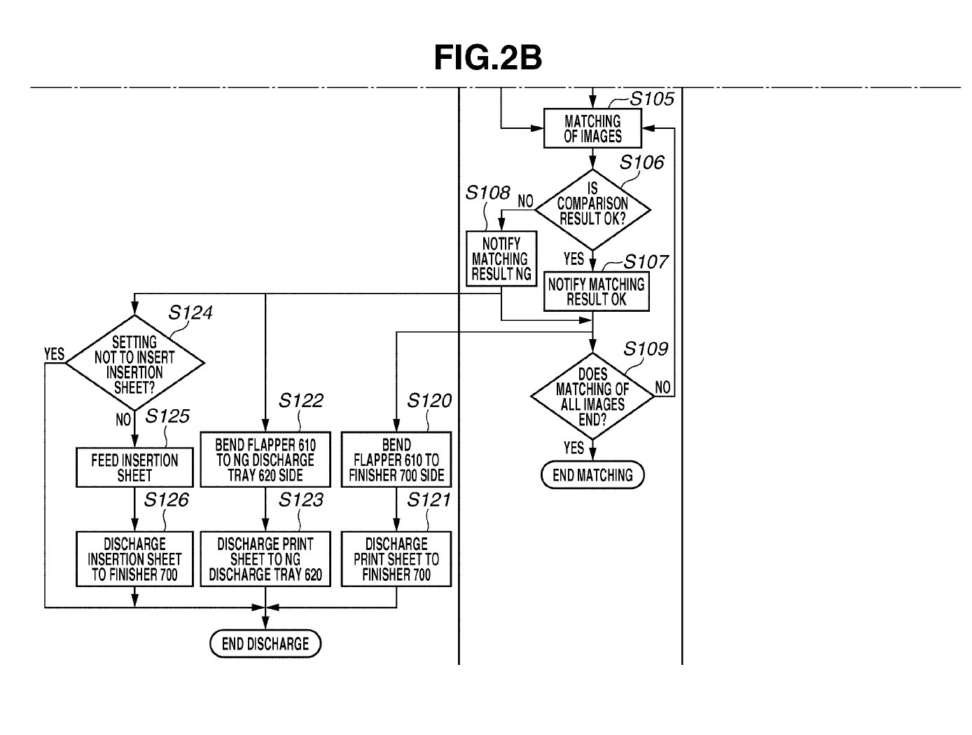

A specific control method is described. A description is given of a checking flow in a copy job for creating 100 copies of one two-sided document and checking the copy result by the checking apparatus 500 with reference to FIG. 2. The present invention is not limited to the copy job and the similar checking processing can be performed in the case of a print job received from an external device.

FIG. 2 illustrates a flowchart of a checking method of the checking system according to the present exemplary embodiment. In an example in FIG. 2, central processing units (CPUs) provided in the MFP control unit 400 and device control units 530 and 630 load programs stored in a read only memory (ROM) on a random access memory (RAM) and execute the loaded programs, thereby realizing the checking processing. In step S100, the checking apparatus 500 receives a checking condition set by the user via the operation unit 540.

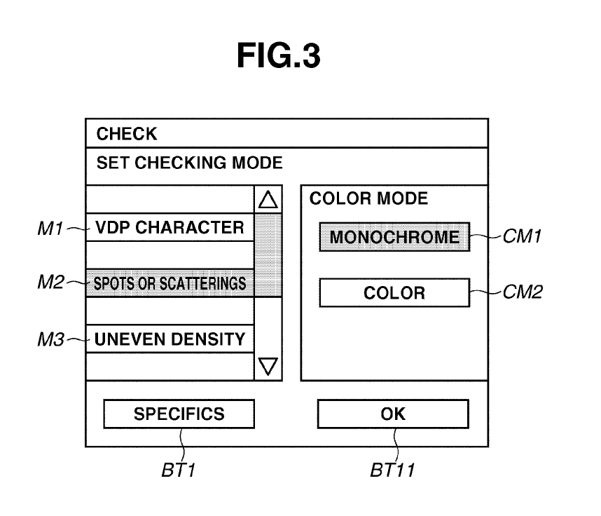

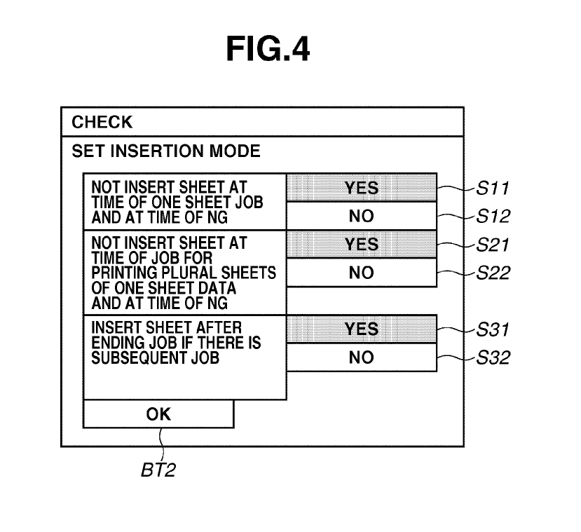

FIGS. 3 and 4 illustrate examples of a user interface (UI) screen displayed on a display portion in the operation unit 540 in the checking apparatus 500 in FIG. 1. The examples in FIGS. 3 and 4 illustrate checking setting screens. On the checking setting screens in the examples, checking modes M1 to M3, a monochrome mode CM1, and a color mode CM2 are displayed. The checking mode M2 (spots or scatterings mode, monochrome) selected by the user is displayed with highlight.

The checking modes M1 to M3 are described according to the present exemplary embodiment. According to the present exemplary embodiment, the checking mode M1 indicates a variable data publishing (VDP) characters mode. The checking mode M2 indicates spots, scatterings, etc. The checking mode M3 indicates an uneven density. According to the present exemplary embodiment, the three checking modes M1 to M3 are illustrated. However, the present invention is not limited to those.

In the checking mode M1 as a mode of the VDP characters, the VDP enables personalized publishing of a printed matter having different targets. For example, in direct mail printing, data having different contents such as zip code or address is printed. In the mode of the VDP characters, it is checked whether the print contents are as expected.

In the checking mode M2 as a mode of the spots or scatterings, it is checked whether the printed matter contains an unexpected image of, e.g., spots or scatterings, white spots, or unexpected lines of toner. In the checking mode M3 as a mode of the uneven density, it is checked whether an output portion has the same density as that of the printed matter. In general, the mode of the VDP characters is a setting valid for the print job. The modes of the spots or scatterings and the uneven density are a setting valid for both the copy job and the print job. A color mode contains the two modes of the monochrome mode CM1 and the color mode CM2. In the monochrome mode CM1, data is read with grayscale having 8 bits. In the color mode CM2, data is read with red (R), green (G), and black (B) each having 8 bits.

On the screen in FIG. 3, the user presses a specifics setting button BT1 as a checking mode. Then, the device control unit 530 shifts the display screen in FIG. 3 to that in FIG. 4. The screen in FIG. 4 is an example screen for setting a sheet feed condition of the insertion sheet fed from the inserter 600. The screen in FIG. 4 is displayed following the checking setting screen. On the screen, the user specifically sets whether insertion processing is executed by relating an insertion mode of the inserter 600 to the number of documents read in the job processing.

Referring to FIG. 4, selection buttons S11 and S12 are provided to set whether the insertion sheet is inserted when the printing is NG (abnormal) time during a job for printing one document per copy. Further, selection buttons S21 and S22 are provided to set whether the insertion sheet is inserted when the printing is NG during a job for printing one document to a plurality of sheets. During the job for printing one document per copy, a plurality of printed matters having the same image is discharged. In this case, if the user subsequently reprints the image that is determined as NG (abnormal), the user may insert the reprinted matter to any portion on the printed matter that is previously printed and is determined as OK (normal). Therefore, the insertion sheet indicating the portion determined as NG may not be inserted to the printed matter that is previously printed and is determined as OK.

According to the present exemplary embodiment, when executing the job for printing one document per copy, the user sets whether the sheet is inserted at the NG time. When executing the job for printing one document per copy, if the user sets that the sheet is not inserted at the NG time, unnecessary use of the insertion sheet is prevented. On the other hand, when executing the job for printing one document per copy, if the user wants to insert the insertion sheet at the NG time, the user sets that the insertion sheet is inserted at the NG time. As a consequence, the user subsequently identifies the portion determined as NG.

Further, selection buttons S31 and S32 are provided to set whether the sheet is inserted after ending the job if there is a subsequent job. The device control unit 530 performs control to highlight the selection buttons (all the selection buttons corresponding to Yes in FIG. 4) of the user. The job for printing one document refers to one document and one copy. Further, the job for printing one document on a plurality of sheets refers to one document and a plurality of copies.

If a button BT2 or BT11 for determining the checking setting is pressed by the user, a reading control device 130 of a document conveyance device 110 detects the document set on a document tray 111 by the user. It is detected whether there are any documents, based on information from an optical sensor (not illustrated) disposed on the document tray 111. In step S110, an operation unit 200 detects pressing of a copy start button (not illustrated) by the user, and instructs the MFP control unit 400 to start copying.

In step S110, when the MFP control unit 400 detects the instruction of the copy start, it instructs the reading control device 130 to start scanning. The reading control device 130 instructs the document conveyance device 110 to convey documents set on the document tray 111 sheet by sheet from the head page, and conveys the documents to a document positioning glass 114 via a curved path.

According to the present exemplary embodiment, copying of a two-sided document is carried out. In step S111, a scanner unit 121 reads an image of the front surface, and an optical unit 113 disposed in the document conveyance device 110 reads an image of the rear surface. An image sensor and a light source (not illustrated) are arranged in the optical unit 113.

In step S112, the optical sensor disposed on the document tray 111 detects whether there are any documents on the document tray 111. The detection result of the optical sensor is notified from the reading control device 130 in the image reading apparatus 100 to an image processing unit 410 in the MFP control unit 400. If it is determined that there is a document on the document tray 111 (YES in step S112), in step S114, the MFP control unit 400 recognizes that a job is done for a plurality of documents. If there are not any documents on the document tray 111 (NO in step S112), in step S113, the MFP control unit 400 recognizes that the job is done for one document.

In step S101, the MFP control unit 400 notifies an image processing unit 510 in the checking apparatus 500 of the recognized information on the number of sheets, and the image processing unit 510 stores the notified information on the number of sheets in a memory unit 520. The checking apparatus 500 notifies the inserter 600 of the information on the number of sheets stored in the memory unit 520. In step S128, the device control unit 630 of the inserter 600 stores the notified information on the number of sheets in a memory (not illustrated). As a consequence, the inserter 600 determines whether the number of sheets printed by the job is one or plural sheets per copy. In step S124, based on the determination result, it is set whether the insertion sheet is to be inserted.

In step S115, the image processing unit 410 performs image processing on the document read by an image sensor 123 via a lens 122, and stores the processed image data in the memory unit 420. Further, the image data is transmitted to an exposure control unit 301 via a printer control unit 330. In step S102, the image data of the document stored in the memory unit 420 is transmitted, as a reference image, to the memory unit 520 in the checking apparatus 500.

The exposure control unit 301 outputs laser beams corresponding to an image signal subjected to the image processing. The laser beams are emitted to a photosensitive drum 302, thereby forming an electrostatic image on the photosensitive drum 302. A developing unit 303 develops the electrostatic image on the photosensitive drum 302. A transfer unit 306 transfers the developer image on the photosensitive drum 302 onto the sheet serving as a print medium fed from one of cassettes 311 and 312 and a manual feed unit 313. In step S116, the sheet onto which the developer is transferred is guided to a fixing unit 304, fixing processing of the developer is performed, and the image is printed on the sheet.

A flapper (not illustrated) temporarily guides the sheet passing through the fixing unit 304 from a path 307 to a path 310. The rear edge of the sheet passes through the path 307, and the sheet is then switched back and is guided from a path 308 to a discharge roller 305. As a consequence, a surface on which the developer is transferred is laid face down, and the sheet is discharged from the printer unit 300 with the discharge roller 305. This is referred to as inversed discharge.

Thus, the sheet is discharged face down, therefore, the image is formed in correct order starting from the head page when printing an image obtained by reading a plurality of documents with the document conveyance device 110. When forming the image on a hard sheet such as an overhead projector (OHP) sheet fed from the manual feed unit 313, the image forming apparatus 10 discharges the sheet from the discharge roller 305 without guiding the sheet to the path 307 while the surface onto which the developer is transferred is laid face up. In the case of forming the image on both the surfaces of the sheet, the sheet as the print medium is guided from the fixing unit 304 to the path 307 and the path 310. Then, the sheet is switched back just after the rear edge of the sheet as the print medium passes through the path 307, and is guided to a two-sided conveyance path 309 with a flapper (not illustrated).

The transfer unit 306 transfers again the electrostatic image onto the sheet guided to the two-sided conveyance path 309, and the fixing unit 304 performs the fixing processing of the image. Thus, a path length, roller arrangement, and a drive system are divided to convey five half-sized (such as A4 or B5) sheets in a loop path from the transfer unit 306 to the transfer unit 306 via the two-sided conveyance path 309. The discharge page order in the processing coincides with the page order in the two-sided copy because an odd-number page is discharged face down.

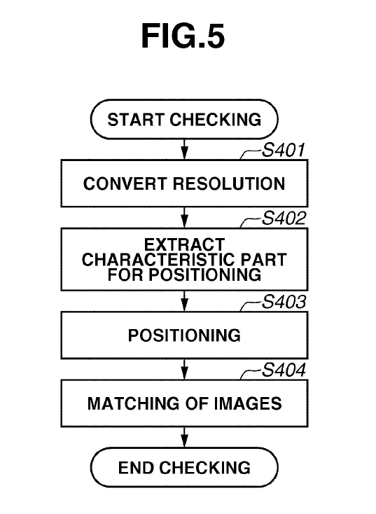

The sheet on which the data is printed by the image forming apparatus 10 is conveyed via a horizontal conveyance path to the checking apparatus 500. The checking apparatus 500 has a detection sensor 560 on a sheet conveyance path. When the detection sensor 560 detects the sheet on the conveyance path, in step S103, a reading control device 550 reads the image printed on the sheet with the optical units 570 and 571. In step S104, the read image data is stored in the memory unit 520. Conveyance rollers 574 to 576 are provided to convey the printed sheet on the conveyance path having the optical units 570 and 571. In step S105, the checking apparatus 500 performs matching of the image data obtained from the MFP control unit 400 in step S102 to the image data obtained in the reading processing in step S104. An example of an image matching method is described with reference to FIG. 5.

In step S106, the system control unit 530 determines whether the matching result of the image data in step S105 is OK (has no spots and scatterings). If the system control unit 530 determines that the matching result of the image data in step S105 is OK (YES in step S106), the processing advances to step S107. In step S107, the checking apparatus 500 notifies the device control unit 630 of the inserter 600 that the matching result is OK, from the device control unit 530. In step S120, the device control unit 630 of the inserter 600 turns up a head of a flapper 610 of the inserter 600. In step S121, the sheet discharged from the checking apparatus 500 passes through the flapper 610 and rollers 612, 613, 614, and 615 in the inserter 600, and is discharged to the finisher 700.

If the device control unit 530 determines that the matching result of the image data is NG (has spots or scatterings) (NO in step S106), in step S108, the device control unit 530 notifies the device control unit 630 of the inserter 600 that the matching result is NG. In response to the notification, in step S122, the device control unit 630 of the inserter 600 turns down the head of the flapper 610 of the inserter 600. In step S123, the sheet discharged from the checking apparatus 500 passes through the flapper 610 and rollers 616, 617, and 618 in the inserter 600, and is discharged to an NG discharge tray 620. Further, the device control unit 630 of the inserter 600 refers to the information on the number of sheets stored in the memory (not illustrated) in step S128.

According to the present exemplary embodiment, the inserter 600 receives information of 100 copies of one two-sided document, as information on the number of sheets. The inserter 600 further receives, from the MFP control unit 400, together with the information on the number of sheets, specific setting information indicating as the setting whether the sheet is not inserted when the result is NG, for the job of printing one document on a plurality of sheets. Therefore, if the device control unit 630 determines that it is set that the sheet is not inserted when NG for the job of printing one document on a plurality of sheets (YES in step S124), the insertion sheet is not inserted, the sheet is discharged, and the processing ends. If the device control unit 630 of the inserter 600 determines that it is not set that the sheet is not inserted when NG for the job of printing one document on one sheet (NO in step S124), in step S125, the inserter 600 operates a feed roller 619 to feed the insertion sheet from an insertion sheet cassette 601.

In step S126, the fed insertion sheet passes through the feed roller 619 and the rollers 612, 613, 614, and 615 in the inserter 600, and is discharged to the finisher 700. Then, the processing ends. The finisher 700 includes a device control unit 730 to control post-processing of the discharged sheet. The device control unit 630 determines the feeding timing of the insertion sheet when the matching result of the images in step S106 is NG, based on the conveyance distance between the flapper 610 and the roller 612 and the conveyance speed of the sheet.

The above checking flow relates to only one page. In the case of a plurality of pages, the similar processing is repeated the number of times corresponding to the number of pages. More specifically, in step S116, the image forming apparatus 10 prints the image. In step S117, the image processing unit 410 determines whether the copying of all documents ends. If the image processing unit 410 determines that the copying of all documents does not end (NO in step S117), the processing shifts to step S119. In step S119, the image forming apparatus 10 reads the next document and executes the processing after step S115.

In the case of the job for printing one printed matter per copy, the processing advances from steps S124 to S125. In step S125, the insertion sheet is inserted irrespective of the specific setting information indicating as the setting whether the insertion sheet is not inserted when NG for the job of printing one document on a plurality of sheets. In step S119, the image of the next document is read. In step S109, the image processing unit 510 determines whether the matching of all images ends. If the image processing unit 510 determines that the matching of all images does not end (NO in step S109), the processing returns to step S105 to perform the matching of the images. If the image processing unit 510 determines that the matching of all images ends (YES in step S109), the processing ends.

According to the present exemplary embodiment, the description is given of the flow for reading the image and simultaneously printing and checking the image. Alternatively, the reading of all documents may end in advance. Then, the image of the document may be printed and checked. The print job can be similarly checked. In the print job, the print job is input to the MFP control unit 400 in the image forming apparatus 10 in FIG. 1, and the reference image is formed.

Further, control can be performed to determine whether the printing continues or stops depending on a jam position. If jam occurs in the rollers 616 to 618 in the inserter 600, the jam does not influence the operation when the matching result of the images is OK. Therefore, only warning is displayed on the operation unit 200 in the image forming apparatus 10 and the processing continues. The printing stops only when the jam influences the operation when the matching result of the images is NG. As a consequence, the operability of the image forming apparatus 10 is improved.

A description is given of an example of the processing for matching the images in step S105 in the flowchart in FIG. 2 for checking the copy, with reference to a flowchart in FIG. 5. The processing in the flowchart in FIG. 5 is realized by loading a control program stored in a ROM on a RAM and executing the loaded control program by a CPU of the device control unit 530. In step S401, the device control unit 530 converts the resolution of the reference image obtained in step S102 with the image processing unit 510. Although reference image data is usually 600 dpi or 1200 dpi, the image for matching is 300 dpi or 150 dpi. Therefore, the processing for converting the resolution is executed.

In step S402, the device control unit 530 extracts a characteristic portion in the reference image for positioning by the image processing unit 510. The resolution for reading the image on the sheet with the optical units 570 and 571 in step S102 matches the converted resolution of the reference image in step S401. That is useful since the resolution conversion is not required for the read print image. In step S403, the device control unit 530 extracts a portion similar to the characteristic portion of the reference image extracted in step S402, from the image data read in step S102. The device control unit 530 calculates an amount of shift, an enlargement/reduction ratio, and a rotational angle by the image processing unit 510 and performs the positioning.

In step S404, the device control unit 530 performs the matching of the reference image data subjected to the resolution conversion, to the image data read in step S102 by the image processing unit 510 to detect whether the print result is OK (normal). In step S405, if the image processing unit 510 determines whether the amount of difference between the two image data as the result of matching the image data is small (YES in step S405), the image processing unit 510 determines that the image is normally printed. If the image processing unit 510 determines that the amount of difference is large (NO in step S405), the image processing unit 510 determines that the image printed on the sheet includes the spots or scatterings.

The image matching processing is not limited to the above method, and various methods may be applied. If the reference image is image data received from an external device, the image processing unit 510 may perform the color space conversion (luminance to density) of the reference image to match the color space of the print image to that of the read image in steps S402 and S403. Therefore, the reference image can be correctly compared with the image read in step S102. Under such control, the portion of the print result determined to be not normal, i.e., NG (abnormal), can be easily seen as the checking result while retaining the productivity of the print system as much as possible. Further, it is possible to prevent unnecessary use of the insertion sheet, which indicates the portion of the print result determined to be not normal, i.e., NG (abnormal), in a plain way as the checking result.

### Other Embodiments

Aspects of the present invention can also be realized by a computer of a system or apparatus (or devices such as a CPU or MPU) that reads out and executes a program recorded on a memory device to perform the functions of the above-described embodiment(s), and by a method, the steps of which are performed by a computer of a system or apparatus by, for example, reading out and executing a program recorded on a memory device to perform the functions of the above-described embodiment(s). For this purpose, the program is provided to the computer for example via a network or from a recording medium of various types serving as the memory device (e.g., computer-readable medium).

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures, and functions.

This application claims priority from Japanese Patent Application No. 2011-107000 filed May 12, 2011, which is hereby incorporated by reference herein in its entirety.

What is claimed is:

1. A checking system comprising:
a checking unit configured to read a sheet on which an image is printed based on image data by a printing unit and check the read sheet; and
a control unit configured to perform control to add a predetermined sheet indicating a portion of a printed matter that is determined to be abnormal by the checking unit to the sheet printed by the printing unit in a case where the number of pages of the image data is greater than one, and not to add the predetermined sheet to the sheet printed by the printing unit in a case where the number of pages of the image data is one.

2. The checking system according to claim 1, wherein the checking unit comprises an obtaining unit configured to obtain image data from the printing unit, and
wherein the checking unit reads the image printed on the printed matter and compares image data generated based on the read image with the image data obtained by the obtaining unit to check the read image.

3. The checking system according to claim 1, further comprising:
a reading unit configured to read a document image and generate image data; and
a counting unit configured to count a number of documents read by the reading unit.

4. The checking system according to claim 1, wherein the checking system further comprises the printing unit.

5. A control method for controlling a checking system, the control method comprising:
reading a sheet on which an image is printed based on image data and checking the read sheet; and
performing control to add a predetermined sheet indicating a portion of a printed matter that is determined to be abnormal by the checking unit to the sheet on which the image is printed in a case where the number of pages of the image data is greater than one, and not to add the predetermined sheet to the sheet printed by the printing unit in a case where the number of pages of the image data is one.

6. A computer readable storage medium that stores a computer program for controlling a checking system, the computer program comprising:
reading a sheet on which an image is printed based on image data and checking the read sheet; and
performing control to add a predetermined sheet indicating a portion of a printed matter that is determined to be abnormal by the checking unit to the sheet on which the image is printed in a case where the number of pages of the image data is greater than one, and not to add the predetermined sheet to the sheet printed by the printing unit in a case where the number of pages of the image data is one.
